(19) United States
(12) Patent Application Publication
(10) Pub. No.: US 2007/0027767 A1
(43) Pub. Date: Feb. 1, 2007

(54) Server apparatus, system, and method for managing use of software

(76) Inventor: Tsunetaka Akagane, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/493,780

(22) Filed: Jul. 25, 2006

(30) Foreign Application Priority Data
Aug. 1, 2005 (JP) 2005-222729

(51) Int. Cl. G06Q 30/00

(52) U.S. Cl. 705/14

(57) ABSTRACT

A server apparatus for managing use of software permits trial use of software in accordance with points of a user. The points are gained by the user performing a predetermined act. The predetermined act includes, but not limited to, browsing a site, answering a questionnaire, receiving a direct mail, purchasing other products or service, or the like.

### CROSS-REFERENCE TO RELATED APPLICATION

This application is based upon and claims the benefit of priority from prior Japanese Patent Application No. 2005-222729, filed on Aug. 1, 2005, the entire contents of which are incorporated herein by reference.

### BACKGROUND OF THE INVENTION

1. Field of the Invention

The present invention relates to a technology of using trial software as a medium of advertisement, information gathering, or the like.

2. Description of the Related Art

It is generally carried out to allow a user to use software on trial before purchasing the software. As a trial use method, there is employed a method that offers the user trial version software with limited available functions for free or at a low price, or that offers the user trial version software with a limited term of use (for example, see Japanese Unexamined Patent Publication (Laid-Open) 2002-366245). By using such a method, there can be expected an effect that it leads the user to know the functions of the target software, as well as raising publicity and promoting purchase.

### BRIEF SUMMARY OF THE INVENTION

In the present invention, a user can use software on trial in accordance with the user's points. The user gains the points by performing a predetermined act. Examples of the predetermined act are, but not limited to, browsing a specific site, answering a questionnaire, receiving a direct mail, purchasing other products or services, and the like.

Thereby, aside from the promotion of purchase of the target software, other merits, such as the promotion of purchase of other services or products, the research of demands or needs of the users, can be facilitated.

The unit of point management can be determined arbitrarily, such as per software installed in a terminal device, per terminal device, per user.

An example of a configuration of the present invention when considered as a server apparatus for managing use of software executed on a terminal device includes: a point generation section for generating points for managing the software; a management database for storing the points; a point request reception section for receiving point request from the terminal device; a point transmission section for transmitting point information including the points stored in the management database in response to the point request; a point remaining quantity reception section for receiving information on point remaining quantity transmitted from the terminal device; a point update section for updating the points stored in the management database with the point remaining quantity received by the point remaining quantity reception section; a service usage information reception section for receiving service usage information indicating that a user of the terminal device has used a service offered by the server apparatus concerned or other server apparatuses; and a point supplement section for supplementing the points generated by the point generation section in accordance with the service usage information received by the service usage information reception section to the points stored in the management database.

In addition, when the present invention is considered as a system for managing use of software having a terminal device and a server apparatus for managing the use of the software executed on the terminal device concerned, the configuration of the server exemplified above is added to the following example of the configuration of the terminal device which includes: a communication device for transferring the information to/from the server apparatus; a point request transmission section for transmitting the point request for requesting the point for performing a main function of the software via the communication device; a point reception section for receiving the points via the communication device; a point consumption section for decreasing sequentially the points received by the reception section in accordance with performance of the main function of the software concerned; and a point remaining quantity transmission section for transmitting the point remaining quantity decreased by the point consumption section via the communication device.

The present invention can also be understood in terms of categories of a recording medium which has recorded a program and of a method.

According to the present invention, aside from promotion of purchase of the target software, purchase of other services, products or the like can be promoted and the demands or needs of the user can be researched simultaneously.

### BRIEF DESCRIPTION OF THE SEVERAL VIEWS OF THE DRAWINGS

These and other features, aspects and advantages of the apparatus and methods of the present invention will become better understood with regard to the following description, appended claims, and accompanying drawings where:

FIG. 1 illustrates a configuration of a system for managing use of software according to a first embodiment of the present invention;

FIG. 2 illustrates a configuration of a terminal device;

FIG. 3 is a block diagram illustrating a configuration of a point server;

FIG. 4 is a schematic flow chart illustrating trial use start processing of software on the terminal device;

FIG. 5 is a schematic flow chart illustrating the trial use start processing of the software on the point server;

FIG. 6 is a schematic flow chart illustrating a processing during trial use of the software on the terminal device;

FIG. 7 is a flow chart illustrating a procedure of point addition processing on a service providing server and the point server;

FIG. 8 is a schematic flow chart illustrating trial use end processing of the software on the terminal device; and

FIG. 9 is a schematic flow chart illustrating the trial use end processing of the software on the point server.

### DETAILED DESCRIPTION OF THE PREFERRED EMBODIMENTS

A preferred embodiment of the invention will be described below with reference to the accompanying drawings.

The fundamental idea of the present invention will be described.

In the present invention, a user gains points by performing a predetermined act and is permitted to use software on trial in accordance with the points. Although trial version software or the like is preferred for the software concerned, it is not limited thereto.

The user can receive the points based on a degree of his/her contribution by browsing a site of a manufacturer or by answering a predetermined questionnaire, for example. The user can also receive the points whenever he/she receives a direct mail such as a mail magazine. In addition, the points can also be gained by purchasing other products, services, or the like. However, the method of gaining the points is not limited thereto.

The user who has gained the points can use desired software on trial in accordance with the gained points.

As a result, aside from the promotion of purchase of the target software of trial use, purchase of other services, products or the like has been promoted and demands and needs of the users have been acquired simultaneously.

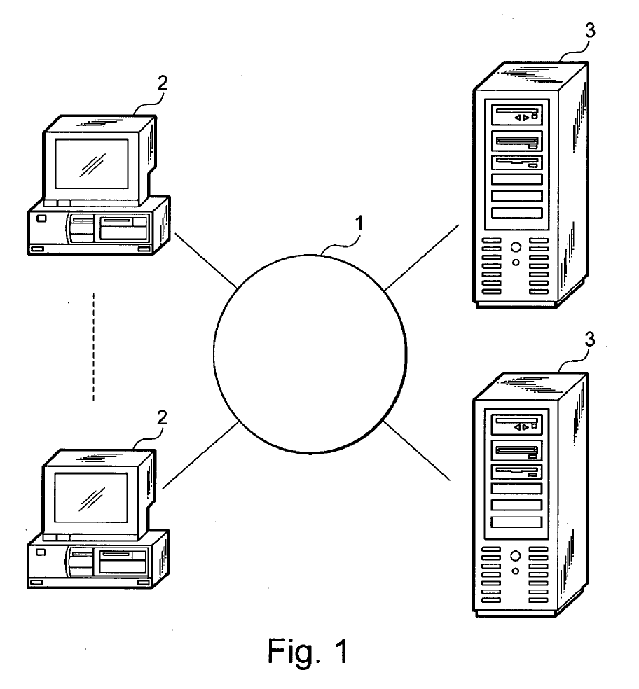

FIG. 1 illustrates a configuration of a system for managing use of software according to a first embodiment of the present invention.

As illustrated in FIG. 1, the system for managing the use of the software includes terminal devices 2, a server 3 for managing use of software (hereinafter, referred to as the “point server”), and a service providing server 4, which are connected to Internet 1.

Here, the terminal device 2 is an information processing terminal owned by the user of the software.

The point server 3 performs managements such as permission of use of the software for the terminal device 2. The point server 3 is the information processing terminal such as a computer owned by the manufacturer of the software.

The service providing server 4 makes an appeal for other software, various services, products, or the like to the user so as to promote purchase. In addition, the service providing server 4 acquires demands or needs of the user. Although the service providing server 4 is usually an information processing terminal such as a computer owned by the manufacturer of the software, it may be an information processing terminal such as a computer owned by the manufacturer of other products.

The point server 3 and the service providing server 4 may be configured so as to transmit and receive information through an intranet, or may be configured as a unitary information processing terminal.

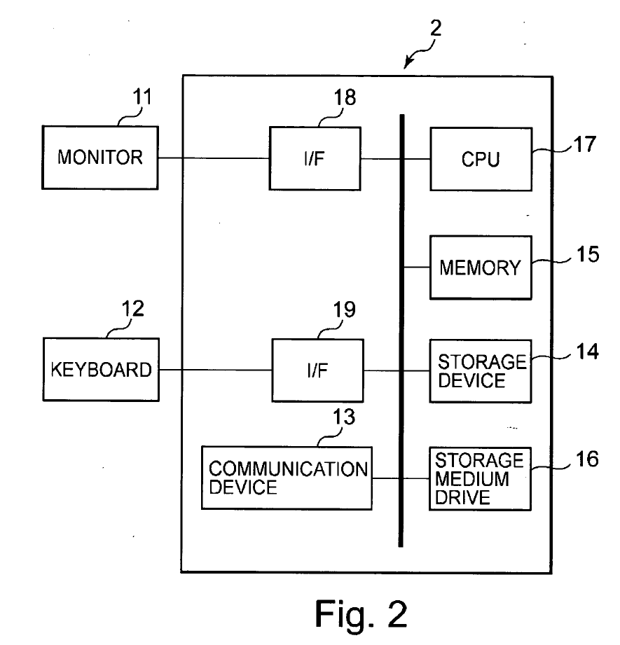

FIG. 2 illustrates a configuration of the terminal device. The terminal device 2 has a monitor 11, a keyboard 12, a communication device 13, a storage device 14, a memory 15, a storage medium drive 16, a CPU 17, and interfaces 18 and 19.

The monitor 11 is a CRT or a TFT liquid crystal display which displays the information. The keyboard 12 is an input device for receiving inputs with the operation by the user.

The communication device 13 transmits and receives management information or the like on the use of the software between it and the point server 3 or the like by communication. The storage device 14 is the storage medium which stores the use management information of the software or the like. The memory 15 is a buffer memory which temporarily stores data required for information processing. The storage medium drive 16 controls I/O of the data to/from an external storage medium. The CPU 17 controls the overall operation of the terminal device 2. The interfaces 18 and 19 control data transfer to/from the monitor 11 and the keyboard 12, respectively.

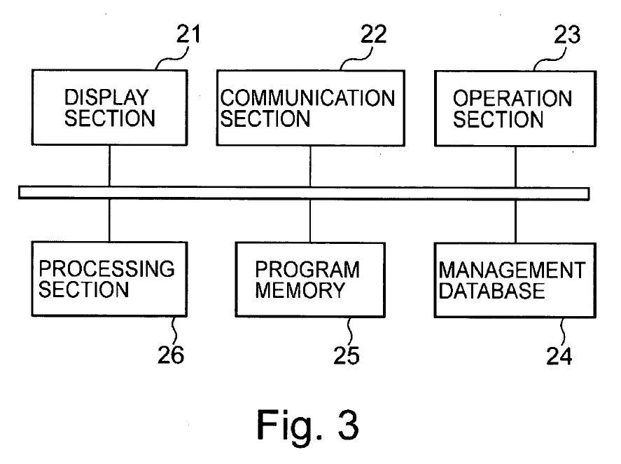

FIG. 3 is a block diagram illustrating a configuration of the point server 3. The point server 3 is provided with a display section 21, a communication section 22, an operation section 23, a management database 24, a program memory 25, and a processing section 26.

The display section 21 is the CRT or the TFT liquid crystal display which displays the information or the like. The communication section 22 performs the data transfer to/from the terminal device 2 or the like. The operation section 23 is an input device such as a keyboard or a mouse for receiving the operation inputs. The management database 24 stores the data for managing the use of the software or the remaining points of the user. The program memory 25 records a program which operates on the point server 3. The processing section 26 controls the overall operation of the point server 3.

Note herein that the configuration of the service providing server 4 is similar to that of the point server 3, and thus detailed explanation thereof will be omitted.

Next, a method of managing and processing the use of the software, using the system for managing the use of the software according to the present invention will be described.

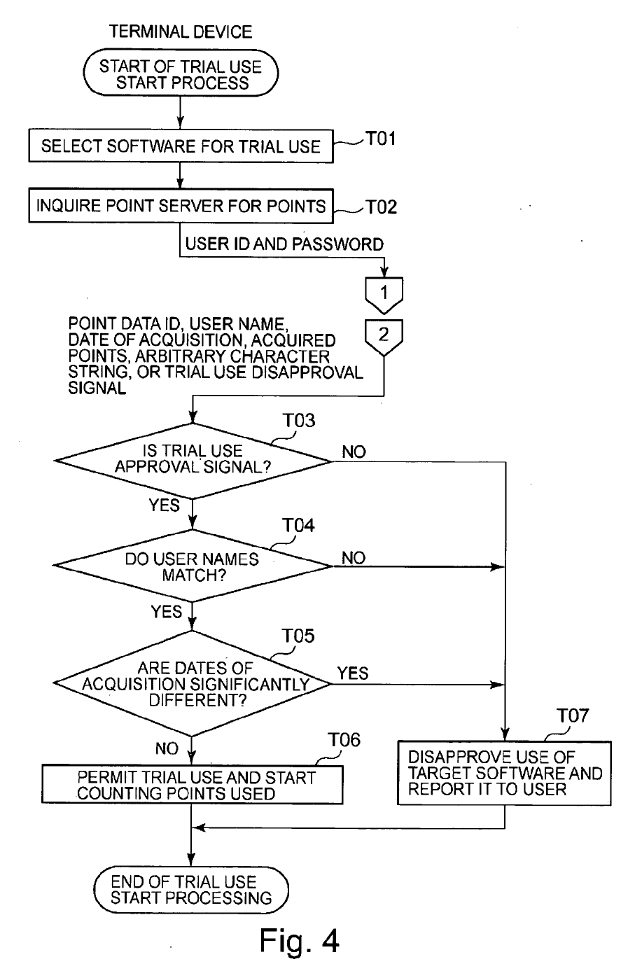

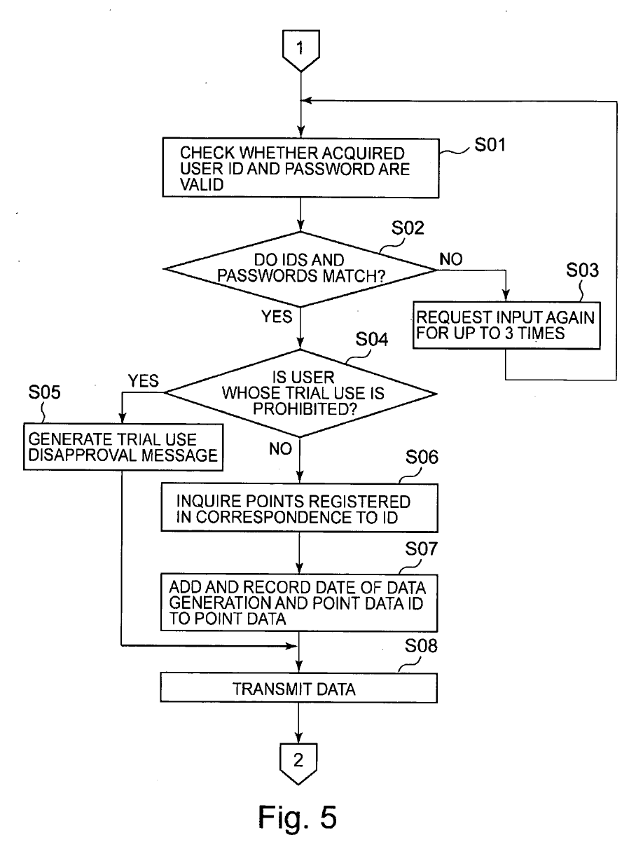

FIG. 4 is a schematic flow chart illustrating trial use start process of the software on the terminal device, and FIG. 5 is a schematic flow chart illustrating the trial use start process of the software on the point server.

When the user activates the software for trial use on the terminal device 2 at step T01 of FIG. 4, a function incorporated in the software concerned operates at step T02 to transmit a request to the point server 3 for inquiring the points in order to perform the main function of the software (a point request transmission function, a point request transmission step). This inquiry request signal includes the information for specifying the user of the terminal device 2, i.e., a user ID and a password. The user has acquired the user ID and the password by carrying out predetermined registration preliminarily.

At step S01 of FIG. 5, the point server 3 receives the point request from the terminal device 2 (a point request reception function, a point request reception step). It is then determined whether the received user ID and password are valid by comparing them with the user ID and password registered in the management database 24. Thereby, the point server 3 authenticates the user (an authentication function, an authentication step).

If the judgment at step S02 is No, i.e., the comparison indicates a mismatch, the terminal device 2 is requested to transmit the user ID and password again at step S03. The request of retransmission may be repeated for up to three times.

If the judgment at step S02 is Yes, i.e., the comparison indicates a match, it is checked whether it is a user whose trial use prohibited at step S04 by searching the management database 24. Here, the reason of prohibiting the trial use includes the case where the user has cheated and altered the points by adding the points.

If the judgment at step S04 is Yes, i.e., the trial use by the user is prohibited, a trail use disapproval message is generated at step S05. At step S08, the message concerned is then transmitted to the terminal device 2.

If the judgment at step S04 is No, i.e., the trial use by the user is not prohibited, the points registered in correspondence to the user ID is checked at step S06 by referring to the management database 24, and point data, which is the data concerning the points, is edited at step S07.

The point data includes a point data ID, a user name, a date of acquisition, acquired points, as well as an arbitrary character string, or the like.

The point data ID is the information which specifies the points, such as an address of the corresponding point data in the management database 24. The user name indicates the name of the registered user. The date of acquisition indicates the date of transmission of the request for inquiring the points. The acquired points indicate the remaining points gained by the user concerned. The arbitrary character string includes other related arbitrary information. It includes, for example, a cryptographic key, a decryption key, or the like.

Then, at step S08, the point data, which is the point information including the points stored in the management database 24, is transmitted to the terminal device 2 in accordance with the above-mentioned point request (a point transmission function, a point transmission step). Alternatively, a use disapproval message is transmitted to the terminal device 2.

Returning to FIG. 4, the terminal device 2 receives the point data, which is the point information including the points, transmitted from the point server 3 via the communication device 13 (a point reception function, a point reception step). The consistency of the data transmitted from the point server 3 is then checked. In other words, it is checked whether the data is a trial use approval signal at step T03, whether the user name matches at step T04, and whether the dates of acquisition are significantly different at step T05.

The fact that the dates of acquisition are significantly different means the case where the date of transmitting the point inquiry request and the date of receiving the point data are considerably different. It includes, for example, the case where transmission is carried out for a different user from the identical user name.

When it is determined that the transmitted data is valid, the user is permitted to use the target software on trial and counting of the points consumed as a result of the trial use of the software is started at step T06.

Meanwhile, when it is determined that the use cannot be permitted on the basis of the transmitted data, the trial use of the target software is disapproved and it is displayed for the user at step T07.

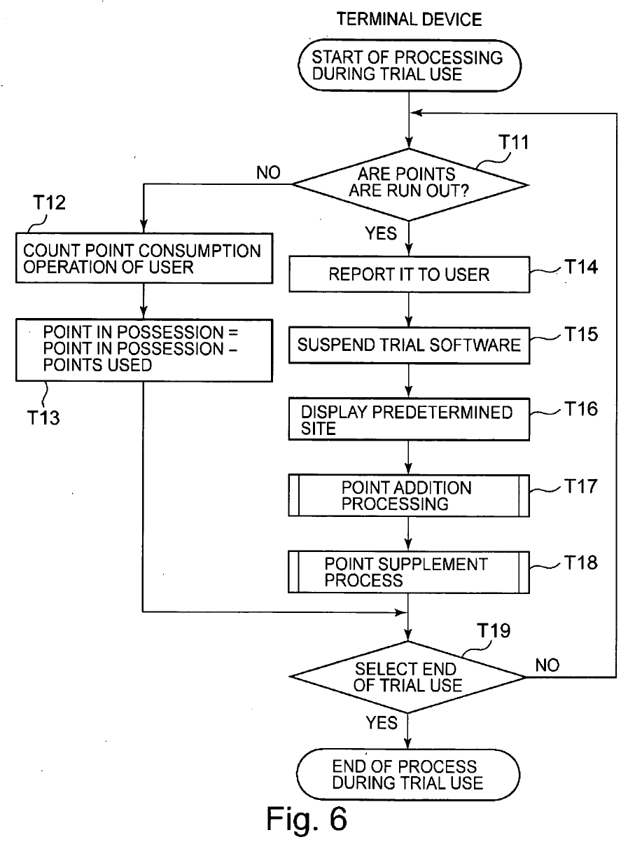

FIG. 6 is a schematic flow chart illustrating process during trial use of the software on the terminal device.

First, at step T11, it is determined whether the points are run out (it becomes zero) for the software in use on trial. When the points are still remaining, the process proceeds to step T12.

At step T12, the points consumed in accordance with the trial use of the software are counted. At step T13, the points used are subtracted from the points in possession to update the points in possession. Thereby, the terminal device 2 subtracts sequentially the received points in response to execution of the above-mentioned main function of the software (a point consumption function, a point consumption step). Note herein that the points consumed by the trial use of the software may be set using various parameters, such as hour of use, access frequency to the data, the number of times of printing, or the like. In this embodiment, it is assumed that the points are consumed in accordance with the hour of use of the software.

If the judgment at step T19 is No, i.e., the trial use of the software is continued, it is checked whether the points in possession remain at step T11, and the processing of above-mentioned steps T12 and T13 are performed repeatedly if the points in possession remain. Between the repetitions, the user can continue using the software on trial.

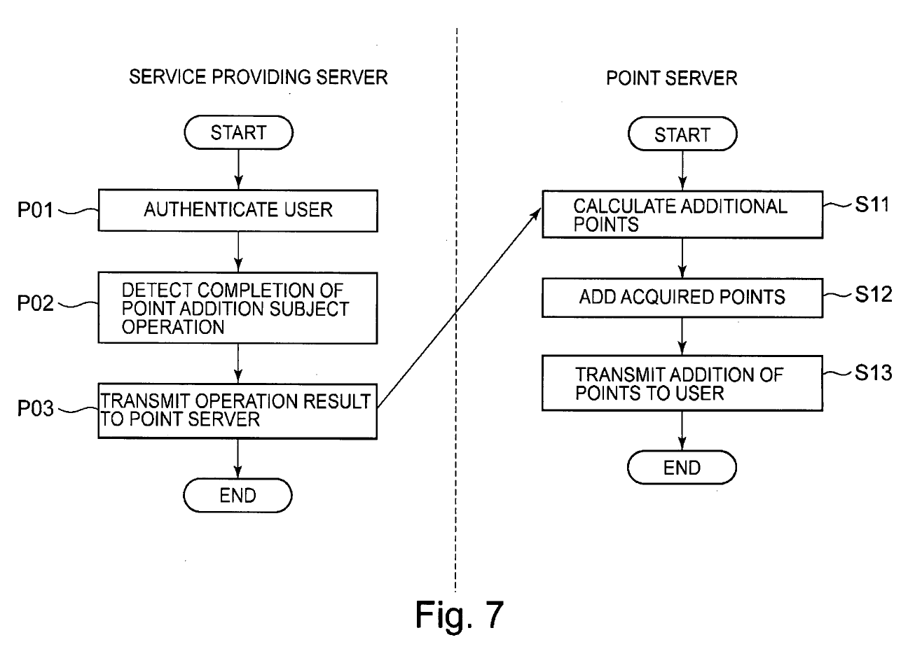

If the judgment at step T11 is Yes, i.e., the points in possession are run out, it is reported to the user at step T14. At steps T15 and T16, the trial software is suspended while a predetermined site is displayed by connecting to the service providing server. Subsequently, point addition processing (FIG. 7) illustrated in step T17 is performed. In this embodiment, the user can access the above-mentioned predetermined site to gain the points by answering the predetermined questionnaire concerning the program in use on trial or by browsing an advertisement movie. It is a matter of course that the operation required to gain the points may be set up variously in accordance with implementation environment of the present invention.

FIG. 7 is a flow chart illustrating a procedure of the point addition process at the service providing server and the point server.

The service providing server 4, at step P01, authenticates whether the user is registered and specifies the user. Then, when it is detected that the user has completed the operation of point addition subject at step P02, the service providing server 4 transmits the operation result of the user to the point server 3 at step P03.

The point server 3 receives the operation result, which is the service usage information, at step S11 (a service usage information reception function, a service usage information reception step). The points to be added are then calculated based on the received service usage information (a point generation function, a point generation step). At step S12, the calculated points are added to the points of the user concerned in the management database 24 and the result is stored in the management database 24 (a point supplement function, a point supplement step). The message indicating that the points have been added is transmitted to the terminal device 2.

Returning to FIG. 6, the terminal device 2 performs point supplement processing illustrated in step T18. The point supplement processing is the processing where the terminal device 2 transmits the point inquiry request to the point server 3 and gains the new points.

Since the content of the processing is substantially similar to that of the trial use start process described by reference to FIGS. 4 and 5, detailed description thereof will be omitted.

If step T19 is Yes, i.e., the user selects to end the trial use of the software, this process during trial use is terminated. When the user does not select to end the trial use at step T19, the process proceeds to T11 again and the trial use will be continued.

Note herein that the point addition processing illustrated in FIG. 7 is performed not only at step T17 of FIG. 6 but also when the user connects to the predetermined site of the service providing server.

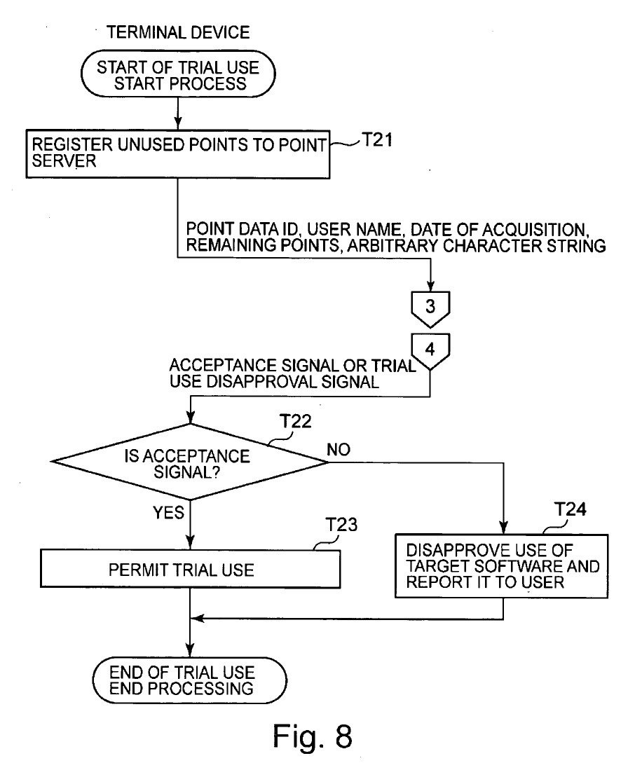

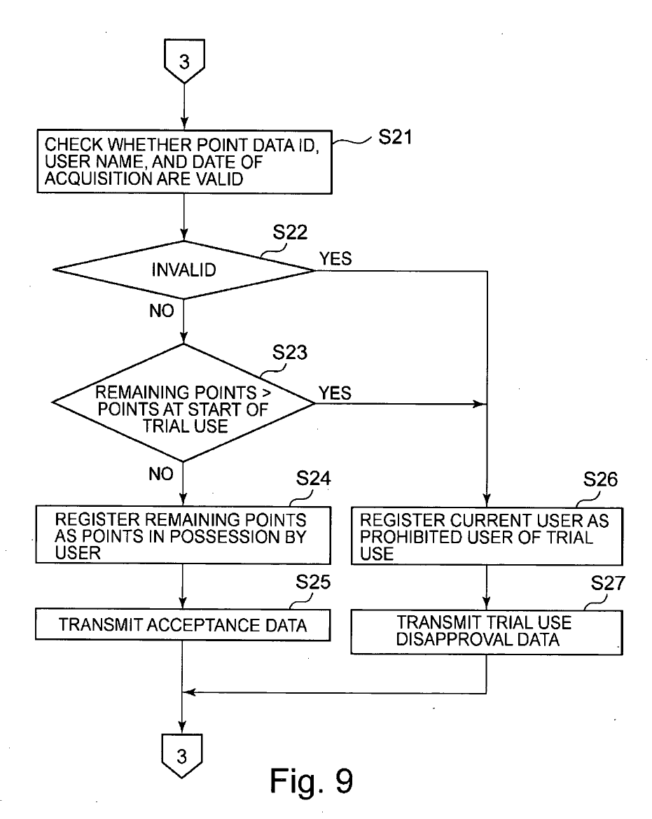

FIG. 8 is a schematic flow chart illustrating trial use end process of the software on the terminal device, and FIG. 9 is a schematic flow chart illustrating the trial use end process of the software on the point server.

At step T21 of FIG. 8, after the trial use of the software ends, the terminal device 2 transmits the point data which is the information of the remaining points or the like to the point server 3 via the communication device 13 (a point remaining quantity transmission function, a point remaining quantity transmission step). The point data includes the information transmitted from the point server 3 at the time of start of using. In other words, the point data is the information including the point data ID, the user name, the date of acquisition, the remaining points, and the arbitrary character string.

At step S21 of FIG. 9, the point server 3 receives the data including the information on the point remaining quantity transmitted from the terminal device 2 (a point remaining quantity reception function, a point remaining quantity reception step). It is then checked whether the point data ID, the user name, and the date of acquisition among the transmitted point data are valid.

Subsequently, the points before trial use and the remaining points are compared. Note herein that, if the points have been added during use, the points before the trial use would be a value including the additional points. However, the points before trial use are normally equal to or more than the remaining points, and if the relationship thereof is reversed, it is considered that any fraud has been probably attempted.

When the check result of the data is valid, the points stored in the management database 24 are updated with the received point remaining quantity at step S24 (a point update function, a point update step) The remaining points are then registered as the points in possession by the user, and the data indicating acceptance thereof is transmitted to the terminal device 2 at step S25.

Meanwhile, if the checked result of the data is invalid, the user concerned is registered as the prohibited user of trial use at step S26, and the data indicating that the trial use is disapproved is transmitted to the terminal device 2 at step S27.

Returning to FIG. 8, the terminal device 2 checks the transmitted signal from the point server 3. If step T22 is Yes, i.e., it is an acceptance signal and then the trial use of the target software is permitted at step T23. Meanwhile, if step T22 is No, i.e., it is the trial use disapproval signal, the trial use of the target software is disapproved and it is reported to the user at step T24.

While the points are managed per user in the embodiment described above, the unit of point management may be changed variously. For example, the points may be managed per terminal device owned by the user or per software that the user uses on trial. When the points are managed per terminal device, the information transferred between the terminal device and the point server includes the information specifying the terminal device, while the information transferred between the terminal device and the point server includes the information specifying the software when the points are managed per software.

In the case where the trial use of the software is once disapproved, a release file may be transmitted from the point server when a predetermined condition is satisfied to thereby approve the trial use of the software. Additionally, the approval of the trial use by the release file may include setup of a limit of a period or the number of times.

The information transferred between the terminal device and the point server (such as the point data) may be enciphered.

In this embodiment, the point generation function, the point update function, and the point supplement function of the point server 3 are the functions of the processing section 26. In this regard, the processing section 26 may be referred to as a point generation section, a point update section, or a point supplement section. The point request reception function, the point transmission function, the point remaining quantity reception function, and the service usage information reception function of the point server 3 are the functions of the communication section 22 which operates under control of the processing section 26. In this regard, the communication section 22 may be referred to as a point request reception section, a point transmission section, a point remaining quantity reception section, or a service usage information reception section.

The point request transmission function, the point reception function, and the point remaining quantity transmission function of the terminal device 2 are the functions of the communication device 13 which operates under control of the CPU 17. In this regard, the communication device 13 may be referred to as a point request transmission section, a point reception section, and a point remaining quantity transmission section. The point consumption function of the terminal device 2 is the function of the CPU 17. In this regard, the CPU 17 may be referred to as a point consumption section.

According to this embodiment, the offer side of the software can advertise the products at low cost by placing the relevant products or other products on the site.

Additionally, opportunities of receiving unfiltered opinions of the users can be increased by means of the questionnaire, allowing the quality opinions of the users at low cost to be received.

The respective functions described in the above embodiment may be configured using hardware or implemented by loading the program, in which the respective functions are recorded using the software, into the computer. Moreover, the respective functions may be those configured by selecting either the software or hardware arbitrarily.

Furthermore, the respective functions may be implemented by loading the program stored in a recording medium into the computer. Note herein that the recording medium in this embodiment may employ any recording format as long as the recording medium can record the program and is computer-readable.

While there has been shown and described what are considered to be preferred embodiments of the invention and it will, of course, and be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A server apparatus for managing use of software executed on a terminal device, the server apparatus comprising:
a point generation section for generating points for managing the software;
a management database for storing the points;
a point request reception section for receiving point request from the terminal device;
a point transmission section for transmitting point information including the points stored in the management database in response to the point request;
a point remaining quantity reception section for receiving information on point remaining quantity transmitted from the terminal device;
a point update section for updating the points stored in the management database with the point remaining quantity received by the point remaining quantity reception section;
a service usage information reception section for receiving service usage information indicating that a user of the terminal device has used a service offered by the server apparatus concerned or other server apparatuses; and
a point supplement section for supplementing the points generated by the point generation section in accordance with the service usage information received by the service usage information reception section to the points stored in the management database.

2. The server apparatus according to claim 1, further comprising an authentication section for authenticating the terminal device or the user of the terminal device.

3. The server apparatus according to claim 1, wherein
the point information transmitted by the point transmission section includes at least one of a point ID specifying the points to be transmitted and date of point request of, as well as a point value, and
the information on the point remaining quantity received by the point remaining quantity reception section includes at least one of the point ID, the date of point request, the information specifying the terminal device, and the information specifying the user of the terminal device, as well as the point value.

4. The server apparatus according to claim 1, wherein
the points are managed per software installed in the terminal device,
the point request reception section receives the point request for using the specific software installed in the terminal device,
the point remaining quantity reception section receives the point remaining quantity of the software transmitted from the terminal device, and
the point update section updates the points corresponding to the software stored in the management database.

5. The server apparatus according to claim 1, wherein
the points are managed per the terminal device,
the point request reception section receives the point request for using the software installed in the terminal device,
the point remaining quantity reception section receives the point remaining quantity transmitted from the terminal device, and
the point update section updates the points corresponding to the terminal device stored in the management database.

6. The server apparatus according to claim 1, wherein
the points are managed per user of the terminal device,
the point request reception section receives the point request for the user to use the software installed in the terminal device,
the point remaining quantity reception section receives the point remaining quantity transmitted from the user of the terminal device, and
the point update section updates the points corresponding to the user stored in the management database.

7. A recording medium with a program recorded therein for managing use of software executed on a terminal device having a communication section which is able to transmit and receive information to/from an external device,
wherein the program causes the terminal device to execute:
point request transmission step for transmitting a point request which requires point information for executing a main function of the software concerned via the communication section;
point reception step for receiving the point information via the communication section;
point consumption step for decreasing a point value contained in the point information received at the reception step in accordance with execution of the main function of the software concerned; and
point remaining quantity transmission step for transmitting point remaining quantity decreased at the point consumption step via the communication section.

8. The recording medium with the program recorded therein according to claim 7, wherein
the point information received at the point reception step includes at least one of a point ID specifying the points and a date of request of the point information, as well as the point value, and
the program causes the terminal device to further execute determination step for determining approval/disapproval of the main function of the software on the basis of the point ID or the date of request of the point information.

9. The recording medium with the program recorded therein according to claim 8, wherein
the point request transmission step transmits at least one of software specifying information for specifying the software which is to execute the main function, terminal specifying information for specifying east the terminal device concerned, and user specifying information for specifying a user of the terminal device concerned, which at least one of information is included in the point request and transmitted therewith.

10. A system for managing use of software having a terminal device and a server apparatus for managing the use of the software executed on the terminal device concerned,
wherein the server apparatus comprises:
a point generation section for generating points for managing the software;
a management database for storing information including the points for managing the software executed on the terminal device;
a point request reception section for receiving point request for requesting the points for using the software from the terminal device;
a point transmission section for transmitting point information corresponding to the software stored in the management server in accordance with the point request;
a point remaining quantity reception section for receiving point remaining quantity of the software transmitted from the terminal device;
a point update section for updating the points corresponding to the software concerned stored in the management database with the point remaining quantity received by the point remaining quantity reception section;
a service usage information reception section for receiving service usage information indicating that a service offered by the server apparatus concerned or other server apparatuses has been used by the terminal device or other terminal devices used by a user of the terminal device; and
a point supplement section for supplementing the points generated by the point generation section in accordance with the service usage information received by the service usage information reception section to the points corresponding to the software stored in the management database,
and wherein the terminal device, which has a communication device for transferring the information to/from the server apparatus, comprises:
a point request transmission section for transmitting the point request for requesting the points for executing a main function of the software via the communication device;
a point reception section for receiving the points via the communication section;
a point consumption section for decreasing sequentially the points received by the reception section in accordance with performance of the main function of the software concerned; and
a point remaining quantity transmission section for transmitting point remaining quantity decreased by the point consumption section via the communication device.

11. The system for managing the use of the software according to claim 10, wherein the server apparatus further comprises an authentication section for authenticating the terminal device or the user of the terminal device.

12. The system for managing the use of the software according to claim 10, wherein
the point information transmitted by the point transmission section includes at least one of a point ID specifying the points to be transmitted and a date of request of the points, as well as a point value, and
the information on the point remaining quantity received by the point remaining quantity reception section includes at least one of the point ID, the date of request of the points, the information specifying the terminal device, and the information specifying the user of the terminal device other than the point value.

13. The system for managing the use of the software according to claim 10, wherein
the points are managed per software installed in the terminal device,
the point request reception section receives the point request for using the specific software installed in the terminal device,
the point remaining quantity reception section receives the point remaining quantity of the software transmitted from the terminal device, and
the point update section updates the points corresponding to the software stored in the management database.

14. The system for managing the use of the software according to claim 10, wherein
the points are managed per the terminal device,
the point request reception section receives the point request for using the software installed in the terminal device,
the point remaining quantity reception section receives the point remaining quantity transmitted from the terminal device, and
the point update section updates the points corresponding to the terminal device stored in the management database.

15. The system for managing the use of the software according to claim 10, wherein
the points are managed per user of the terminal device,
the point request reception section receives the point request for the user to use the software installed in the terminal device,
the point remaining quantity reception section receives the point remaining quantity transmitted from the user of the terminal device, and
the point update-section updates the points corresponding to the user stored in the management database.

16. The system for managing the use of the software according to claim 10, wherein
the point information received by the point reception section includes at least one of the point ID specifying the points and the date of request of the points as well as the point, and
further comprising a determination step for determining approval/disapproval of the main function of the software on the basis of the point ID or the date of request of the points.

17. The system for managing the use of the software according to claim 10, wherein
the point request transmission section transmits at least one of software specification information for specifying the software which is to execute the main function, terminal specification information for specifying at least the terminal device concerned, and user specification information for specifying the user of the terminal device concerned by including the information in the point request.

18. A method of managing use of software of a server apparatus for managing the use of the software executed on a terminal device, comprising:
generating points for managing the software;
storing the points in a management database;
receiving point request from the terminal device;
transmitting point information including the points stored in the management database in accordance with the point request;
receiving information on point remaining quantity transmitted from the terminal device;
updating the points stored in the management database with the point remaining quantity;
receiving service usage information indicating that a user of the terminal device has used a service offered by the server apparatus concerned or other server apparatuses; and
supplementing the points generated in accordance with the received service usage information to the points stored in the management database.
